(19) United States
(12) Patent Application Publication
(10) Pub. No.: US 2003/0212624 A1
(43) Pub. Date: Nov. 13, 2003

(54) Timeshare skills

(76) Inventors: Sundeep Sanghavi, Fairfax, VA (US); Hemal Shah, Atlanta, GA (US)

Correspondence Address: SUNDEEP SANGHAVI, 4604 CAMBRYAR ST., FAIRFAX, VA, 22030, US

(21) Appl. No.: 10/140,039

(22) Filed: May 8, 2002

(51) Int. Cl. G06F 17/60

(52) U.S. Cl. 705/37

(57) ABSTRACT

This invention applies the concept of time-sharing to help fill the needs of industry for a pool of highly skilled individuals at a more affordable rate then if they were required to maintain a sufficient skilled workforce for projects that evolve out of a highly dynamic environment. Simply stated individuals with the skill sets needed by business and industry would contract with the provider and be placed in the Time Share Skills (TSS) database system. Business and Industry would buy or place an order from the Time Share Skills (TSS) provider the projected needed skills for a time in the future at a rate that would be significantly less then if they had to hire and develop the projected work force for projects.

### BACKGROUND OF THE INVENTION

In the highly dynamic demand of skills in today's information technology environment budget allocation for human skills has become a serious concern for employers. Skills required today become extinct tomorrow, and staffing with state-of-the-art skills requires frequent altering of human resource budgets. The information technology era placed a high demand for computer programmers that has been difficult to meet. Currently industry is faced with an increased demand for networking engineers that is hard to meet. At the same time the high demand for computer mainframe skills of the 1980's is dying out and being replaced by demands for personal computer skilled in such systems as Oracle.

In many cases the success or failure of a project is directly related to a company's ability to acquire the required human resources in a timely and economical manner. In most cases human resource budget allocation occurs annually. Due to the highly dynamic business environment of today it has become difficult to rely on human resource acquisition practices that worked well in a less dynamic business environment. Previously human resource needs could be identified and budgeted annually with a reasonable degree of certainty that projected needs would be filled as needed at or near the amount allocated in the budget. In today's highly dynamic business environment this is no longer the case. It is increasingly difficult to project annual staffing requirements and budget for those projected needs with a reasonable degree of certainty the projected needs will be met within the project budget.

In the current dynamic business environment, companies tend to under staff or over staff for certain skill sets. When a project is completed the skill set pool that is no longer needed all too often becomes idle and ends up becoming an unnecessary continued overhead for the employer. The idle skill set pool could be made available to other companies who have need for personnel with those skills with the correct system in place.

Two major systems have been in place for many years that provide a temporary solution for utilizing idle costly skill sets not needed by one employer, but needed by another. In one system companies have a history of leasing employees with specific skill sets to other companies who have a current need for that skill set until such time the need arises again for that skill in their company. When this occurs, the need for one company to reduce overhead costs is satisfied by the other company that contracts for the use of an idle skill set. In the other system companies hire temporary help from outside providers specializing in providing skilled employees on a temporary basis. Such practices tend to be very costly for projects that last significantly longer than originally expected.

In addition to the highly dynamic business environment that exits today, there are freelance specialists that have skills and experience that are not being used as efficiently as they may be. Freelance specialists are available who have empty time slots that could be filled with assignments if a system was in place that would track their excess available time and match it with employers who have the need for the specialist's skills. There is no system presently in place to effectively accomplish this task.

This invention provides a distinctly different method for matching the needs of employers with human resources that have the skill sets to necessary to satisfactorily accomplish work assignments in a timely manner and more economically attractive rates.

### SUMMARY OF THE INVENTION

Time-sharing is a concept that has been successfully applied to real estate developments as a means to allow more than one owner to share with others the use of a vacation property for a fixed number of days each year over a fixed number of years or as an investment that can be passed on to heirs of an estate, or sold to another investor. This invention applies the concept of time-sharing in a new way.

The time-sharing of a vacation property benefits both the developer of vacation properties and the owner of a time-share. The owner of a time-share in a property or group of properties has the benefit of being able to schedule annual use of the property for a specific period of time at a desirable location for a reasonable monthly expenditure each year. On the other hand the developer of the vacation property benefits by being able to develop more attractive properties that are affordable for a larger number of users.

This invention applies the concept of time-sharing to help fill the needs of industry for a pool of highly skilled individuals at a more affordable rate then if they were required to maintain a sufficient skilled workforce for projects that evolve out of a highly dynamic environment. Simply stated individuals with the skill sets needed by business and industry would contract with the provider and be placed in the Time Share Skills (TSS) database system. Business and Industry would buy or place an order from the Time Share Skills (TSS) provider the projected needed skills for a time in the future at a rate that would be significantly less then if they had to hire and develop the projected work force for projects.

### BRIEF DESCRIPTION OF THE DRAWINGS

FIG. 1(a) illustrates the applicability of time share skills system according to the invention.

FIG. 1(b) illustrates the process of placing individuals with the needed skill sets in the TSS database and the process business and industry would use to acquire time shares of the required skill sets for upcoming projects.

FIG. 2 is a detailed illustration of individual transactions of the processes illustrated in FIG. 1 for both the input of skills by the provider to the TSS database system and the purchase of time-share skills by user members from the database.

FIGS. 3 and 4 provide a detailed flow of how the purchaser of time-share skills submits requests and logs the necessary data on the TSS database system.

FIGS. 5 and 6 provide a detailed flow of how individuals log skill sets on to the TSS database system.

FIGS. 7-10 provide the detailed filter process for accessing and storing time-share skills purchaser activity.

FIGS. 11-14 provide the detailed filter process for accessing and storing skill sets information by providers.

### DETAILED DESCRIPTION OF THE INVENTION

Each of the figures describing the elements of the invention will be described in detail in this section. It is to be understood that the following descriptions are only exemplary of the principles of the invention, and should not be viewed as narrowing the scope of the claims in any way.

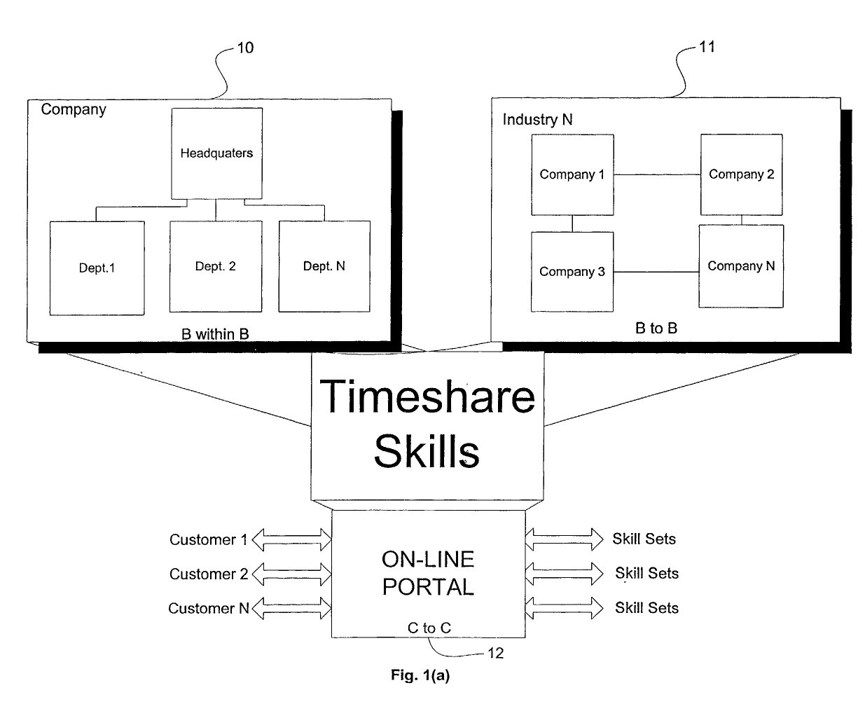

As shown in FIG. 1(a), time-sharing of skills can be applied within the domain of a single company or organization 10. Typically these are large size companies that have several functional departments (Dept. 1, Dept. 2 . . . Dept. N). In many instances, for example, maintenance of computer networks, within each department is a periodic activity. Employing an expert in the field may not be justifiable, if a single department expects the maintenance period to last only 3-4 months. But by posting the requirement and making it known that the department is in “partial” need of this expertise, the other groups/departments within an organization with a similar need may pool resources to make the skills available. The skills are “time-shared” by several groups/departments within an organization/enterprise.

This methodology will also allow clarity in budget allocation, and make projects that were not feasible due to budget constraints, possible. The actual medium through which communication will take place for posting requirements, attracting other groups, and pooling resources, can be various. One way is development of a software product that is installed Enterprise wide, whereby, such needs are established and met. The corporate office/HR group may be an intermediary.

Yet another case is applying time-sharing within organizations that belong to the same industry (11). In this case, a consortium of companies that have interest, but insufficient resources individually, come together to time-share certain skill sets that typically do not offer the competitive advantage to their organization but, have great value in competing with the fast-paced technological changes that may occur around them. Thus there is an inevitability in the companies (Company 1, Company 2, Company 3 . . . Company N) coming together to synergies there effort to manage these advances in science and business.

For example, application is in the construction industry, where several construction houses, come together to developing technological/software tools that will assist their industry. It is not justifiable for one organization to invest their time and money in the necessary research and development. After completion of the necessary project, those resources generated, which are now overheads, can be “time-shared”.

Yet another example is providing an online portal (12) to time share skills between customers (Customer 1, Customer 2, . . . Customer n) and skill sets pool.

FIG. 1(b) is a block diagram of the primary elements of a time-share skills system used in this invention. In this system, a plurality of remote terminals access time share skills database 100 through a gateway and filter process. In the time-share skills system prospective customers (104, 105, 106) and/or skill set providers (101, 102, 103) can gain access over telephone\electronic medium. The time-share skills filter process is the middle layer system between the gateway and the time-share skills database that filters the distinct processes designated for customers and skill set providers requests, which will be explained more in detailed later.

In this example, three customers and three skill-set providers are illustrated. These numbers are only by way of example. In actual implementation, it is intended that the system utilize a network such as the Internet or an Intranet, having thousands of users who can access the system.

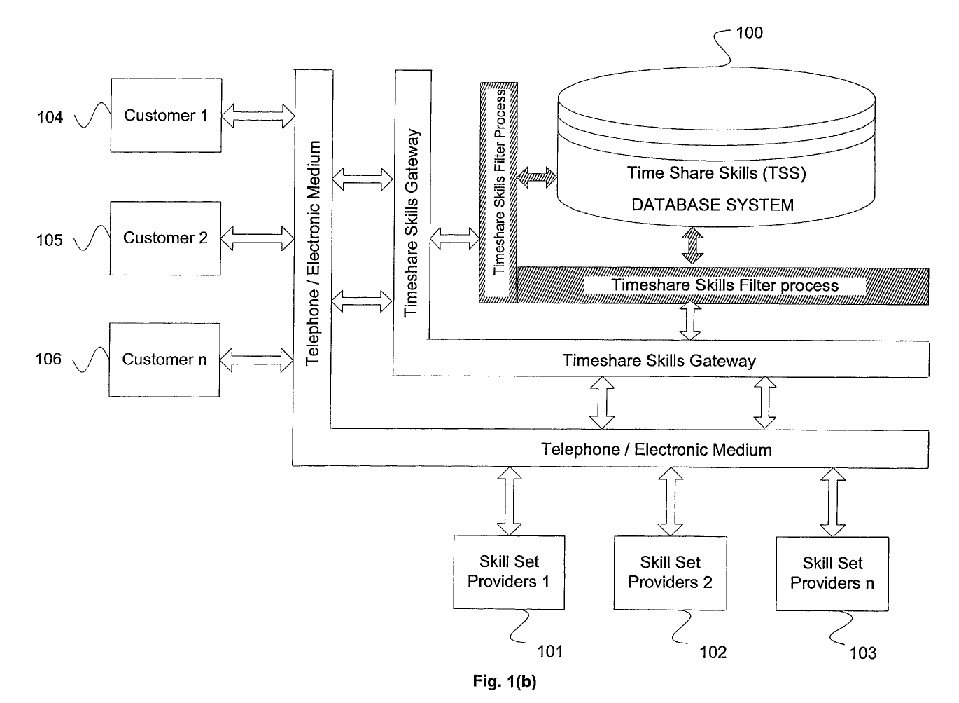

FIG. 2 goes one step further and illustrates the typical flow that occurs when the Time-Share Customer interacts with the TSS:

1) The TSS Customer locates the TSS web page

2) Determine membership status

a) If member go to step 3

b) If not either

i) Submit a membership agreement or

ii) Exit system

3) Enter user PIN

4) View account information

5) Buy, sell, or trade points

6) Update status

7) Confirm

8) Exit system

FIG. 2 also illustrates the typical flow that occurs when the Skill Set Provider interacts with the TSS:

1) The TSS Skill Set Provider locates the TSS web page

2) Determine membership status

a) If member go to step 3

b) If not either

i) Submit a membership agreement or

ii) Exit system

3) Enter user PIN

4) View account information

5) Alter personal skill sets, accept or reject offers, etc.

6) Update status

7) Confirm

8) Exit system

Considering a generic case, the TSS user is first identified as a member. In case the answer is in the negative, an option is made available wherein the TSS customer can sign a contract. Members are identified from their User Name and PIN. On confirmation they enter through a secure terminal and the complete TSS Customer Account Information is displayed. Here the TSS customer has several options regarding the type of activity he wishes to perform, for example Buy/Sell/Trade TSS points. This process is typically an interactive process between the customer and an intelligence system that aids the TSS customer and makes intensive comparisons and analysis to filter information usable to the customer based on his contract. After some level of decision making on the part of the intelligence system, their status is then updated, and followed by a confirmation from his part. Similar to the flow that is followed by the TSS Customer, the TSS Skill Set Provider is also required to be a member and this is checked at an early stage. TSS Skill Set Providers also have an option to sign a contract with TSS. User Name and PIN is checked and the TSS Skill Set Provider profile is made available. Among the several things the profile shows are a calendar system identifying the period during which he is required to offer his skill(s), his status (current points per hour). It should be noted that this value is dynamic in nature based on the supply and demand of the TSS Skill Set Provider. The Skill Set Provider may alter his skill set, accept, reject or perform a similar operation and send it back to the TSS system after which the data submitted updates the relevant areas including his account information. Before exiting the TSS provider is requested to confirm the changes made to his account information.

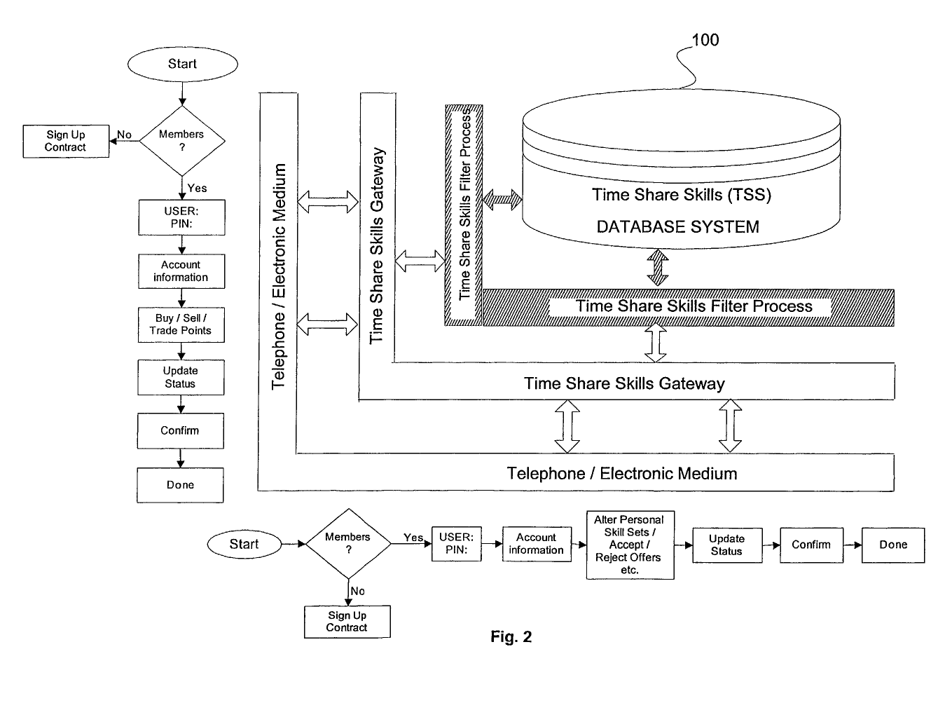

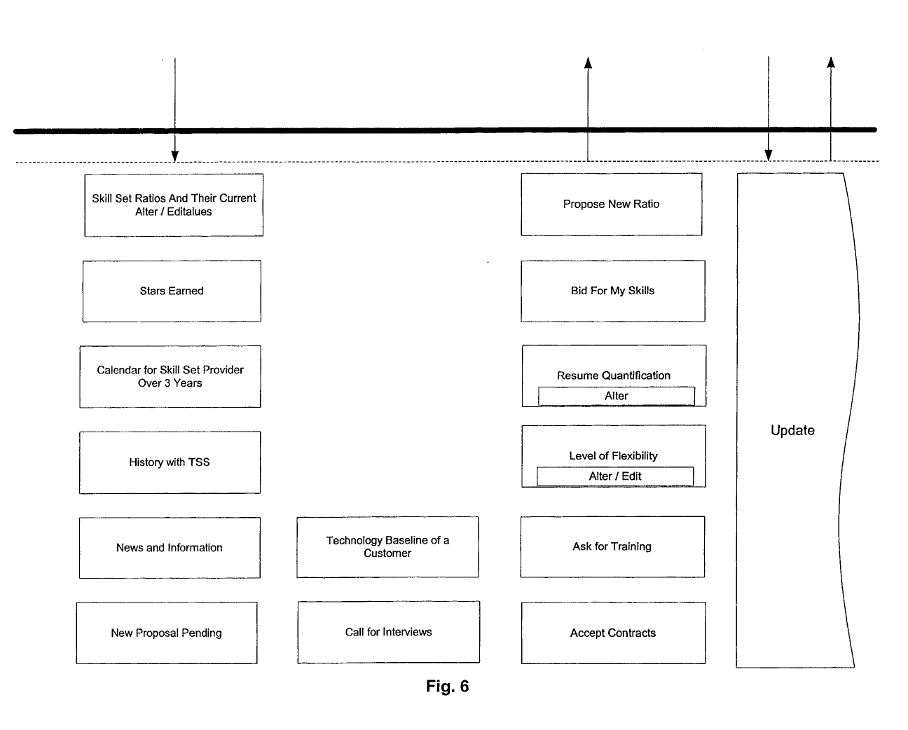

FIG. 3 details the TSS Customer interface with TSS database system. It is a detailed illustration of how the information entered by the TSS customer is being processed through TSS filter which retrieves information from the TSS database and stores it back to the TSS database. For example, the TSS customer enters signup/login information through telephonic/electronic medium and the TSS gateway enters the TSS filter. The TSS filter processes the information through process (a) that will be described latter with respect to FIGS. 7-10. The TSS filter retrieves the information based on the filtering process from the TSS database and the account information is presented to the TSS customer. Similarly, the TSS customer inputs information regarding the buy/sell/trade points through process (b) of the TSS filter. The TSS filter intelligence processes the information optimally and sends the updated information back to the TSS customer. The TSS customer has the option to confirm the update information or edit and send back the information for reprocessing. The TSS customer exits the system after confirming the update process.

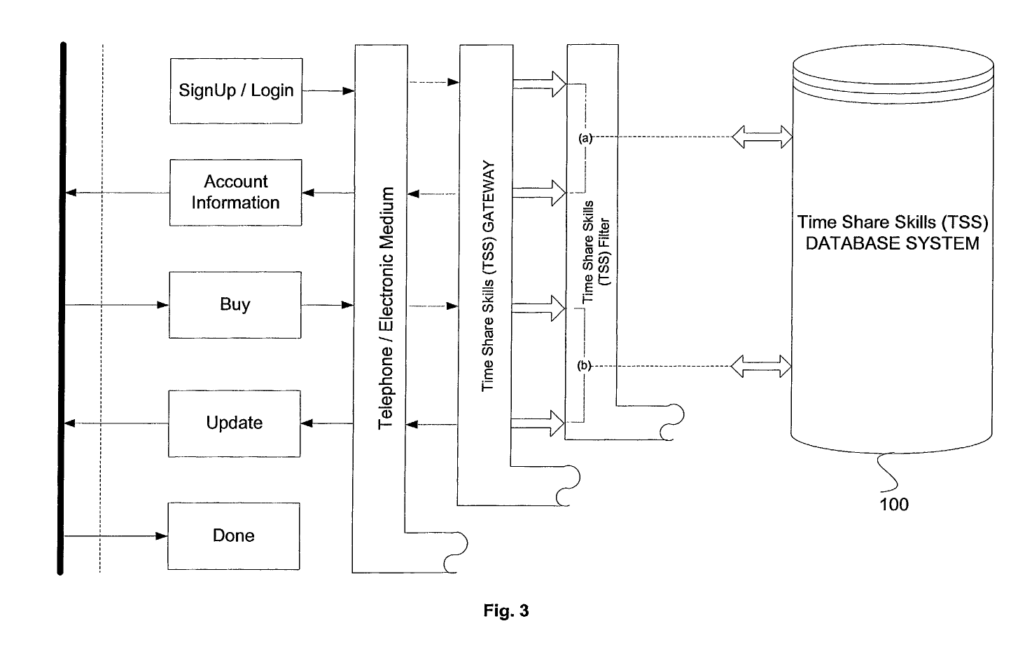

FIG. 4 illustrates the process involved with TSS customer account information (200, 201) and options available to the customer for taking actions on the account. As explained in the FIG. 3 example, the TSS database filter in combination with the TSS database displays information back to the customers. FIG. 4 identifies the TSS Customer Account Number, TS points, TSS news and events, history of TS points used, and contract details that can be accessed by the TSS customer. Also, the scheduled deals in the pipeline for TSS Skill-Sets are available for viewing. The TSS database also keeps and maintains information on a technology baseline of each TSS Customer.

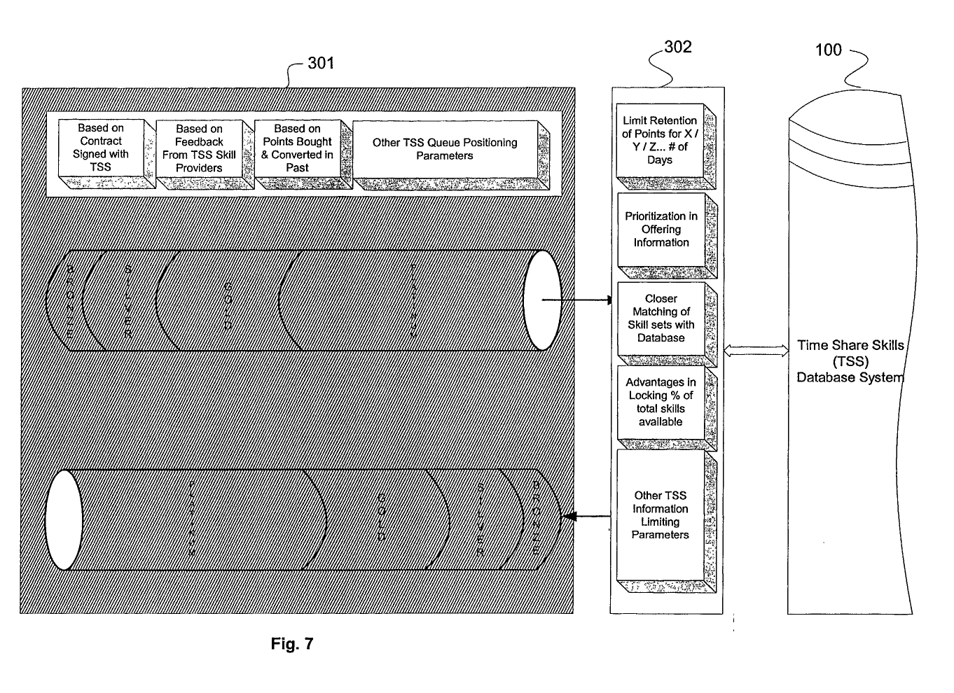

TSS customers can take actions from the available options based on the account information. The TSS customer can buy TS points to access skill sets for the future. The TSS customer can use points to acquire skill sets. The TSS also allows TSS customers to sell, auction, exchange or bid skill sets, which will be explained with reference to FIGS. 8-10. After every action a TSS customer takes the TSS filter checks and processes the information and updates the customer information in the TSS database.

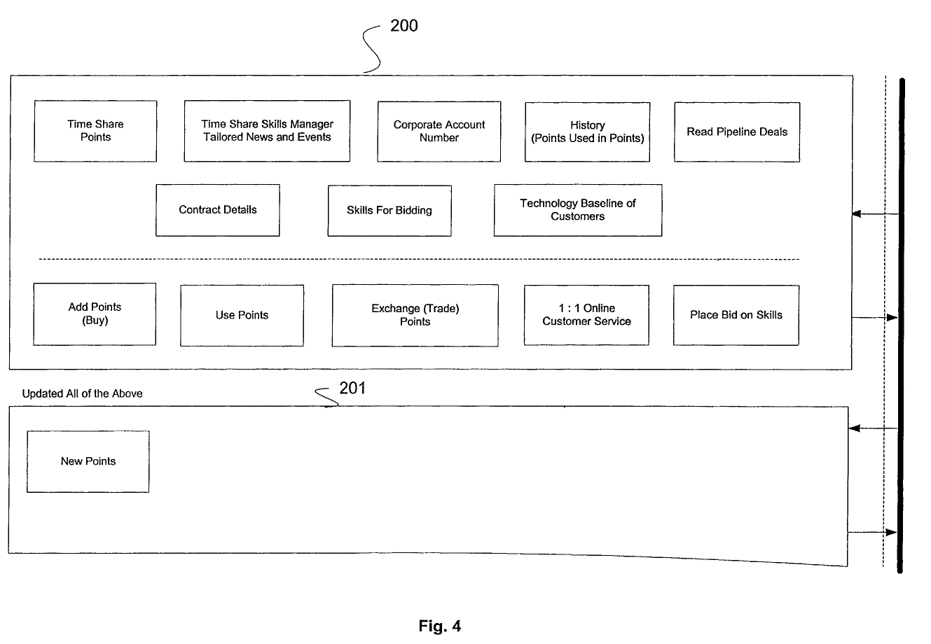

FIG. 1(b) details the Skill-Set provider interface with TSS database system. FIG. 5 is a more detailed illustration of how the information entered by the Skill-Set provider is being processed through TSS filter which retrieves from the TSS database and stores information back to the TSS database. For example, a TSS Skill-Set provider goes through the login process by providing the necessary information through telephonic/electronic medium and the TSS gateway enters the TSS filter. The TSS filter processes the information through process (c) that will be described latter. The TSS filter retrieves the information based on the filtering process from the TSS database and the personal information is presented to the TSS Skill-Set provider. Similarly, the TSS provider can change personal information, scheduling, or skill-sets that are process through process (d) of the TSS filter. The TSS filter intelligence processes optimally the information and sends back the update information back to the TSS provider. The TSS provider has the option of confirming the update information or editing it and sending the information back for reprocessing. The TSS provider exits the system after confirming the update process.

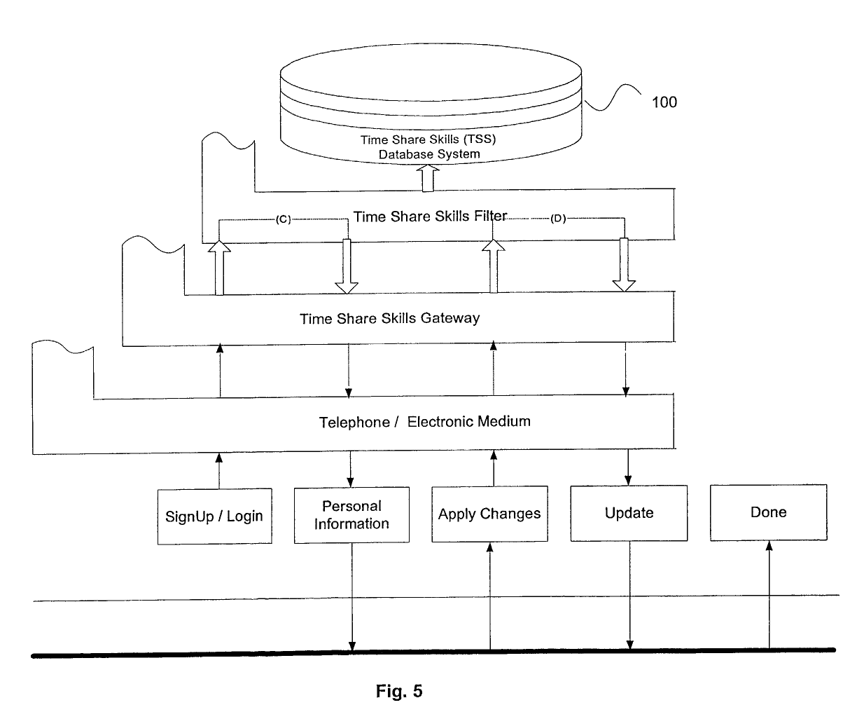

FIG. 6 is a detailed illustration of the personal information of the TSS providers and options available to them to perform actions on the account. As explained earlier in FIG. 5, the TSS filter in combination with the TSS database displays information back to the TSS providers. Similar to FIG. 6, skill set ratios and their current value, a three-year scheduling calendar, TSS news and events, provider history with TSS, and contract details can be accessed by the TSS providers. Pending proposals can also be accessed.

TSS providers can take actions from the available options based on their personal information. The providers can accept TSS contracts from the customers. TSS providers can view their schedules according to the TSS contracts. The providers also can change their level of flexibility for certain time periods. The TSS also allows providers to auction their skills and ask for training from the TSS training center. The TSS filter checks, processes, and updates the information in the TSS database after every action taken by the TSS provider.

FIG. 7 illustrates how the TSS users achieve the premium status level of Platinum, Gold, Silver, or Bronze.

TSS user status level can be mathematically written as:

C(p)>C(g)>C(s)>C(b)

Where C(p) is the user with a platinum profile, and C(b) is the user with a bronze profile. Each of the users is given priority and options available from TSS based on their status level. The user with platinum status has the highest priority and most options while customers with bronze status have the lowest priority and fewest options. User status is quantified by TSS positioning parameters such as contract with TSS, feedback from skill sets providers and points bought and converted in past. According to the user status level, TSS will prioritize offering information, provide closer matching in skill sets, and also provide advantage of locking percent of skill sets.

FIG. 8 illustrates the action (401) in purchase of a skill-set executed by a TSS user described in FIG. 4. The user identifies the number of skill-set providers needed with respective skill-set ratios. The market performance ticker is checked for value of these skill sets and determines points required for purchase based on the ratios. After receiving the customer confirmation skill sets are locked. After time “X” customer requests candidate and the TSS reports the customer on available candidate.

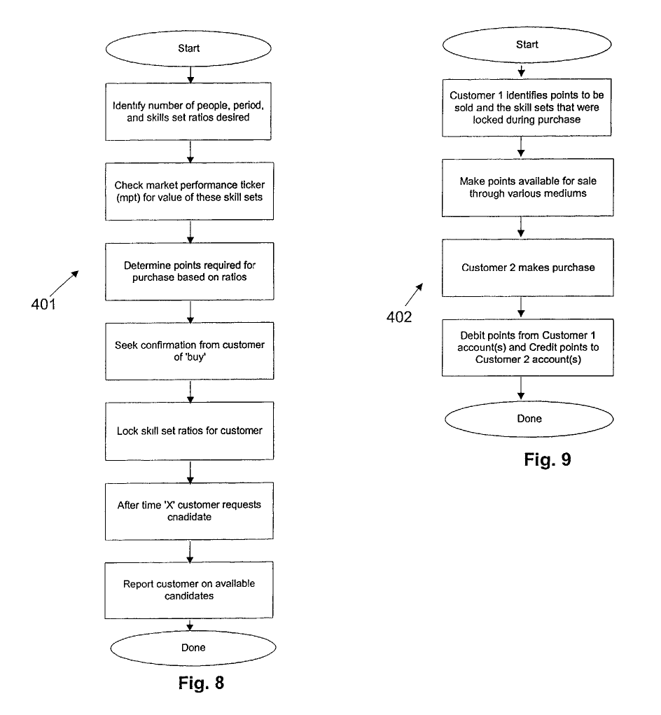

If customers fail to utilize their locked skill set ratios, they can sell the skill sets to other customers within the pool in need. As shown in flow diagram 402 of FIG. 9, the customer 1 makes the points available for sale and customer 2 makes the purchase for the locked skill set. The points are automatically deducted and added according to transaction made by the customers.

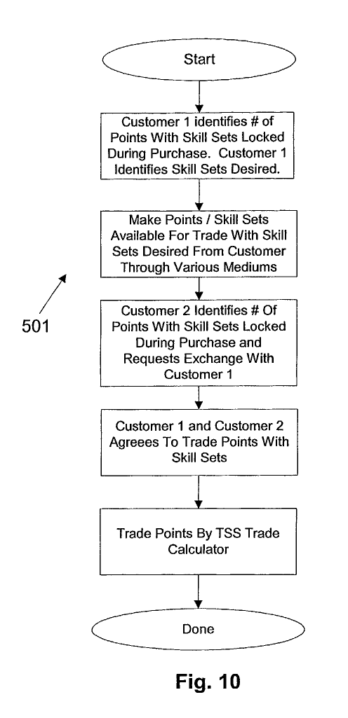

As shown in flow diagram 501 of FIG. 10, trading of points between TSS user 1 (C1) and TSS user 2 (C2) can be allowed within the system. The trading customers must have common skill sets (A, B, C, etc.) that were locked during purchase. For example, if C1 has skills sets A, B, C, L, P, R and C2 have P, Q, R, X, Y, Z against which their points were bought. Then points that can be traded between C1 and C2 can be P and R only. If x was the number of points that C1 purchased against skill set P and y was the number of points that C2 purchased against skill set Q then—if x>y then C1 can trade no more than y points. And the new locked skill sets for C1 and C2 will be C1−A, B, C, L, P (balance after deduction), R(increased) C2−Q, R, if y>x then C2 can trade no more than x points.

Performance appraisals are one of the variables used to determine the status of the customers and skill-sets providers. For example, the TSS user will evaluate the skill-set provider and feed in the results to TSS database. The TSS database will accumulate appraisals and feed in the accumulated information to a TSS appraisal system. The TSS appraisal system will pass information down to the TSS filter to adjust ranking of the skill-set providers. Similarly, skill-set providers will also evaluate the working environment of the company after completion of the project. This evaluation will be also fed to the TSS database. The entire process will be kept confidential through separate accounts. The accounts monitor reliability of the skills of the person through appraisal and also monitor skill set provider experience with the company.

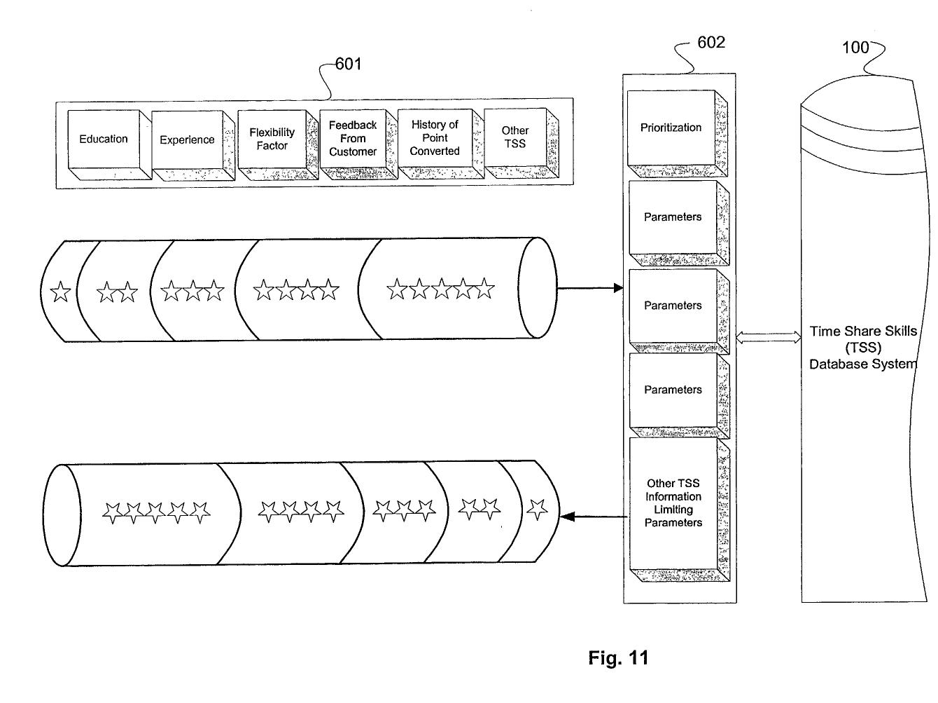

FIG. 11 provides a closer look at the functioning and purpose of the TSS filter system, which is similar to the job it performs for information flow in and out for the user (FIG. 10). The positioning factors in the case of the Skill-Set provider are: Education or Training; Experience; and Flexibility factor, which is based on several factors such as relocation flexibility, etc.

Positioning factors determine the where the skill-set provider stands in a queue in information delivery. Each skill-set provider maintains a particular value of points which very based on the supply and demand of the projects they are offered and also based on their past performance. Provider positioning factors are expressed by the following formula:

SSP1[1]>SSP2[2]>SSP3[3]>SSP4[4]> . . . SSPn[n′]

Where SSPn represents a unique skill set provider that holds an account with TSS and n′ is his rank or priority status. With 1 having the topmost priority and n′ having the lowest priority.

Let A, B, C, etc. be the different skill sets that are available. Typical Examples of these will be programming, database management, etc. Every Skill-Set Provider can hold one or more of these skill sets, and he shall be represented in his abilities as a percentage of A, B, C, etc. Provider skill-set evaluations will be done by a TSS counselor taking into consideration their education, experience and flexibility. To do this the counselor would relate his skills with those providers currently registered. This benchmarking exercise will yield a result similar to the following:

A:B:C=80% a:15% b:5% c

This means that the candidate (SSP) has proved an 80% proficiency in skill set A and has hence earned 80% of the ongoing benchmark rate closest to his background (education, experience and flexibility). Similarly, 15% proficiency in skill-set B and 20% proficiency in skill-set C. For all other skill sets say X, Y, Z, the provider holds proficiency values equal to zero.

The ongoing rate for each of these skill sets can be assumed to be:

a1, b1, c1, . . . etc for SSP1

a2, b2, c3, . . . etc for SSP2

the difference is due to the level of education, experience and flexibility-factor ‘k’.

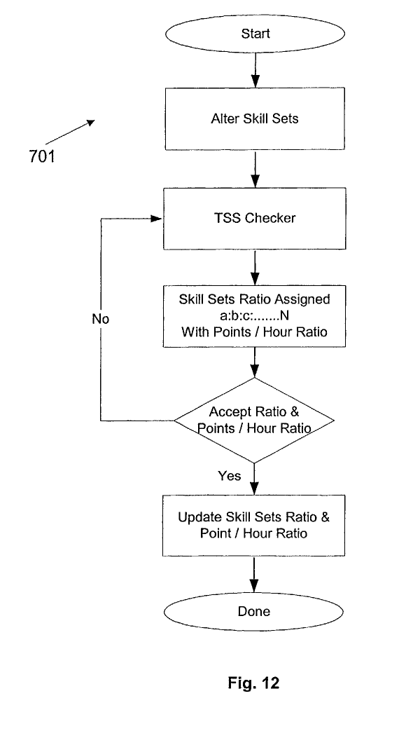

For example, consider SSP(p). On quantifying his background the counselor suggests these values a(p), b(p), c(p) . . . etc. for this SSP(p). Once this is done he (the SSP's skill-sets) form a part of an integral set that is based on demand and supply relationship. For instance, another SSP(q) recently signs a contract (with one of the TSS users) it would mean there would be an immediate shortage of the skill sets that SSP(q) was rated for and his values a(q), b(q), c(q) would increase in value. But not only that, SSP's close to him (for the purpose of this example say SSP(p)—that means typically sharing similar skill sets and backgrounds) would also see a trickling effect and hence a slight increase in the skills that were common to both, although the rise would be less for SSP(P) than it would be for SSP(q). The system will be set up and implemented in such a way that it imitates real world conditions and market values. The motivation to every employee will be to increase these values, a, b, c . . . etc. This means that customers will have to pay more to hire the candidate for the project. As shown in flow diagram 701 of FIG. 12, the skill sets ratio and point/hour ratio assigned to the skill sets. The skill set is check through TSS checker and the skill sets ratio and point/hour ratio is updated.

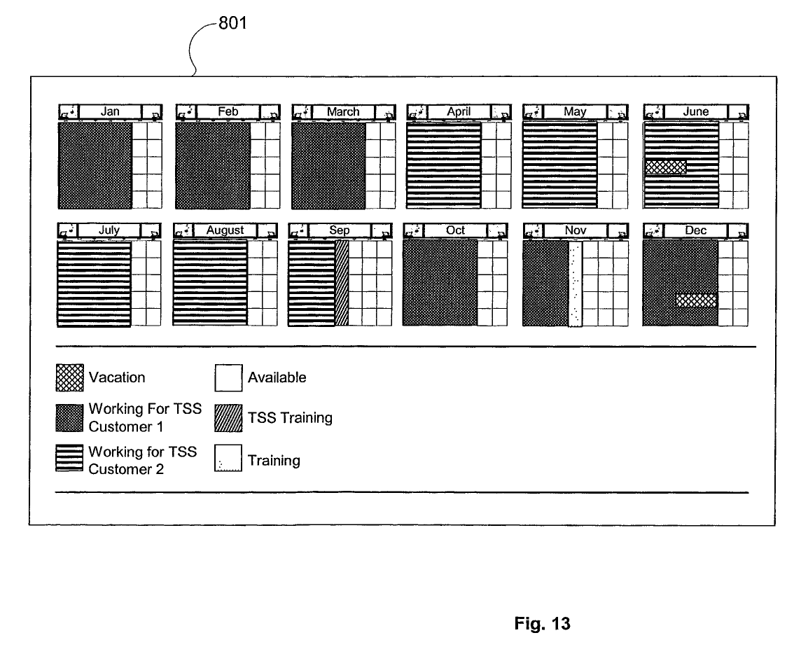

FIG. 13 shows how the dates in the calendar are filled based on selected and confirmed activities by both the customers and skill set providers. It shows when the skill set chooses to take vacation, the confirmed contractual working for the customers and training.

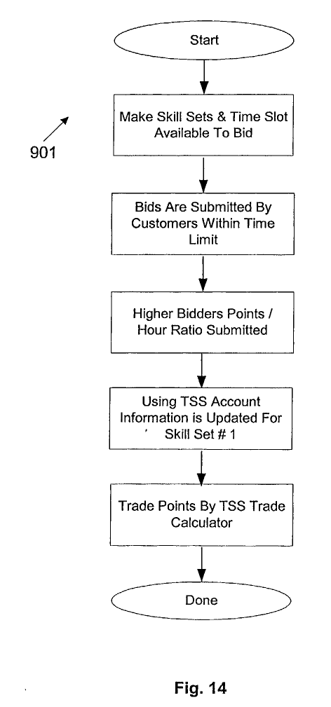

The flow diagram 901 of FIG. 14 shows how the skill set provider can auction it skill within the system. The skill set provider makes it skill sets and time slot available to bid. Customers within the time limit submit bids and the highest bidder wins the skill set and TSS trade calculator automatically deducts points from the customer.

It is important to note here, the main difference between the above example and the Time-sharing of skills within a single company, is the issue of ‘ownership’. In the above example (online Portal), it is the liability of the online portal managing company that takes responsibility in providing the right skills at the right time, and with the best distribution. But for the second case (Time-sharing of skills within a single company), all groups/departments that are coming together will have ‘ownership’.

Many modifications may be made without departing from the scope of the present invention taken in its general characteristics.

We claim:

1) A method for timesharing skills comprising:
buying time share skills points through a Time Share Skills database system;
using said points to accommodate need of skill sets.

2) The method of claim 1 further comprising, searching skill sets available in the TSS database system.

3) The method of claim 1 further comprising, allocating time share points based on requested skill sets.

4) The method of claim 1 further comprising, exchanging time share points through the TSS database system.

5) The method of claim 1 further comprising, auctioning of time share points through the TSS database system.

6) The method of claim 1 further comprising, selling of time share points through the TSS database system.

7) The method of claim 1 further comprising, assigning a skills set ratio to a skill set provider.

8) The method of claim 1 further comprising, displaying a calendar for an individual skill set provider.

9) The method of claim 7 further comprising, altering said skill set ratio through a time share skills checker.

10) A time share skills system comprising:
means for storing customers and skill set providers information; and
means for providing time share skills to the customer.
